(19) United States
(12) Patent Application Publication
(10) Pub. No.: US 2020/0380652 A1
(43) Pub. Date: Dec. 3, 2020

(54) AUTOMATED GENERATION OF SYNTHETIC LIGHTING SCENE IMAGES USING GENERATIVE ADVERSARIAL NETWORKS

(71) Applicant: SIGNIFY HOLDING B.V., EINDHOVEN (NL)

(72) Inventors: OLAITAN PHILIP OLALEYE, WAKEFIELD, MA (US); JIAN GAO, CAMBRIDGE, MA (US)

(21) Appl. No.: 16/881,066

(22) Filed: May 22, 2020

Related U.S. Application Data
(60) Provisional application No. 62/854,716, filed on May 30, 2019.

(30) Foreign Application Priority Data
Jun. 7, 2019 (EP) 19178985.8

(51) Int. Cl. G06T 5/50; G06T 7/70; G06T 11/00; G06T 3/60; G06T 5/00; G06K 9/00; G06K 9/62; G06N 3/04; G06N 3/08

(52) U.S. Cl. CPC G06T 5/50; G06T 7/70; G06T 11/001; G06T 3/60; G06T 5/008; G06T 2207/20212; G06K 9/6256; G06N 3/04; G06N 3/088; G06T 2207/20081; G06T 2207/20084; G06K 9/00624

(57) ABSTRACT

This disclosure is directed to systems and methods for automated generation of lighting scene images. An image of an environment is provided to the system, and lamps with particular light styles can be added to various locations on the image. A modified image of the environment which includes the added lamps and light styles is generated using a generative adversarial network. The generative adversarial network focuses on one or more zones around the added lamp and applies learned or pre-specified decay functions to the light style in the zones.

### FIELD OF THE DISCLOSURE

The present disclosure is directed generally to systems and methods for automated generation of synthetic lighting scene images using generative adversarial networks.

### BACKGROUND

Efficient and accurate large scale generation of images which show lighting effects is challenging. Accordingly, there is a need to develop better methods for generation of images showing lighting effects.

### SUMMARY OF THE DISCLOSURE

This disclosure is directed to systems and methods for automated generation of lighting scene images. An image of an environment is provided to the system, and lamps with particular light styles can be added to various locations on the image. A modified image of the environment which includes the added lamps and light styles is generated using a generative adversarial network. The generative adversarial network focuses on one or more zones around the added lamp and applies learned or pre-specified decay functions to the light style in the zones.

Generally, in one aspect, a method for automated generation of lighting scene images is provided. The method comprises: receiving an image of an environment; receiving a location on the image of an environment of a first added lamp or obtaining a learned location on the image of an environment of the first added lamp; identifying one or more zones at varied distances from the first added lamp; inserting an image of the first added lamp on the image of an environment; identifying one or more spatial light style decay functions suitable to the image of an environment based on the first added lamp; and generating, using a conditional generative adversarial network, a modified image of an environment, wherein the modified image shows the first added lamp and shows one or more light styles from the first added lamp.

In another aspect, the method further comprises at least one of the steps of: receiving or learning one or more spatial light style decay functions; and receiving or learning one or more interaction constraints regarding light style.

In another aspect, the learned location on the image of an environment to insert the first added lamp is determined by a modified object detection network or a regional proposal segmentation based neural network.

In another aspect, the method further comprises the step of transforming the modified image using the conditional generative adversarial network or style transfer network. Transforming the modified image comprises at least one of: rotating the modified image; altering a view point of the modified image; and changing ambient background conditions.

In another aspect, the conditional generative adversarial network comprises one or more generator models and one or more discriminator models.

In another aspect, the one or more light styles are regarding at least one of: color, brightness, spectrum, shadow, reflectivity, hue, and light source location.

In another aspect, the conditional generative adversarial network is trained using image pairs where one image of the image pairs shows an environment with in-place lamps and another image of the image pairs shows an environment without in-place lamps.

In another aspect, the conditional generative adversarial network is trained using images with one or more in-place lamps. The method further comprises the steps of: running a detection model to detect a mask of the one or more in-place lamps and lamp styles of the one or more in-place lamps; removing the mask of the one or more in-place lamps; and removing one or more in-place lamp styles using image decomposition.

Generally, in one aspect, a system for automated generation of lighting scene images is provided. The system comprises: a first computing device, having a first communication module, a first memory, and a first processor, and a second computing device, having a second communication module, a second memory, and a second processor. The first processor is configured to: send, to a second computing device via the first communication module, an image of a lighting environment. The second processor is configured to: receive, from the first computing device via the second communication module, an image of an environment; receive a location on the image of an environment of a first added lamp or obtain a learned location on the image of an environment of a first added lamp, from the first computing device via the second communication module; identify one or more zones at varied distances from the first added lamp; insert an image of the first added lamp on the image of an environment; and generate, using a conditional generative adversarial network, a modified image of an environment, wherein the modified image shows the first added lamp and shows one or more light styles from the first added lamp.

In another aspect, the system further allows the second computing device to be configured to: receive or learn one or more spatial light style decay functions; and receive or learn one or more interaction constraints regarding light style.

In another aspect, the system further allows the first processor of the first computing device to be configured to: send, to the second computing device via the first communication module, one or more light styles regarding the first added lamp.

In another aspect, the second processor is further configured to apply one or more spatial light style decay functions to the image of the environment.

In another aspect, the second processor of the second computing device is further configured to transform the modified image using the conditional generative adversarial network or style transfer network. Transforming the modified image comprises at least one of: rotating the modified image; altering a view point of the modified image; and changing ambient background conditions.

In another aspect, the conditional generative adversarial network comprises one or more generator models and one or more discriminator models.

In another aspect, the one or more light styles are regarding at least one of: color, brightness, spectrum, shadow, reflectivity, hue, and light source location.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic representation of a lighting scene image generation system according to aspects of the present disclosure.

FIG. 2 is a schematic representation of images of lighting scenes according to aspects of the present disclosure.

FIG. 3 is a schematic representation of a modified image of a lighting scene according to aspects of the present disclosure.

FIG. 4 is a schematic representation of a training process for a generative adversarial network according to aspects of the present disclosure.

FIG. 5 is a schematic representation of a training process for a generative adversarial network according to aspects of the present disclosure.

FIG. 6 is a flowchart showing a method of automated generation of a lighting scene image according to aspects of the present disclosure.

FIG. 7 is a flowchart showing a method of automated generation of a lighting scene image according to aspects of the present disclosure.

FIG. 8 is a schematic representation of a learned location of a lamp according to aspects of the present disclosure.

### DETAILED DESCRIPTION OF EMBODIMENTS

The present disclosure is directed to systems and methods for the automated generation of lighting effects on user provided images using generative adversarial networks. The systems and methods allow a user provided image to be transformed to show the effect of an overlay of different lighting effects, and any viewpoint or re-arrangements, efficiently and accurately on a large scale. The systems and methods allow customers to better visualize how lighting products will look in their homes. A modified image of an environment is generated using a generative adversarial network, generative model, or style transfer model. The generative adversarial network, generative model, or style transfer model transforms the provided images to show different lighting styles provided by automatically inserted lamps of various types. The model achieves great performance by using learned or pre-specified decay functions which enable more efficient and faster convergence. This leads to the generation of higher resolution and better quality outputs. The generative adversarial network, generative model, or style transfer model can show direct illumination from a user inputted source where the model learns light transfer patterns irrespective of the spatial location of the lamp in training images. In addition, by restricting the search space over which to calibrate loss parameters, which can be focused on lighting consistency, CRI, color, or intensity, the model can converge early.

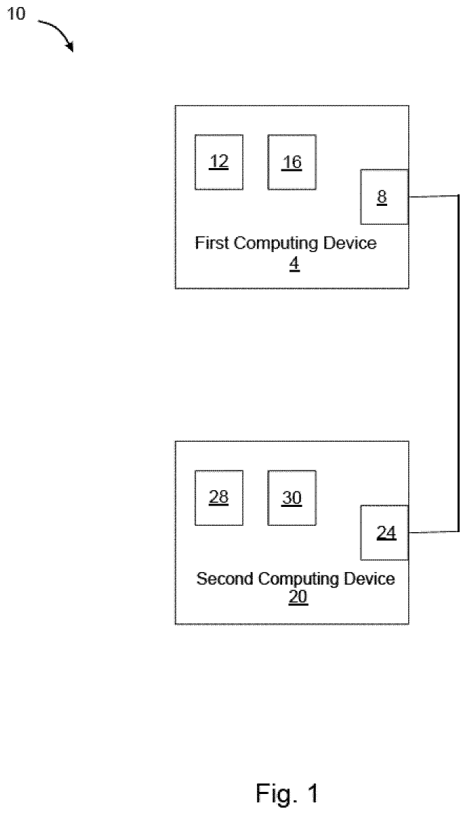

Referring to FIG. 1, a system 10 for automated generation of lighting scene images is shown. The system 10 has a first computing device 4, having a first communication module 8, a first memory 12, and a first processor 16. The system 10 also has a second computing device 20, having a second communication module 24, a second memory 28, and a second processor 30. The first computing device 4 and the second computing device 20 can be any computer such as a desktop, laptop, computer, a server (in the cloud), mobile computing device (such as a smartphone, tablet, or wearable device), or combination including at least one of the foregoing, or any other computerized device.

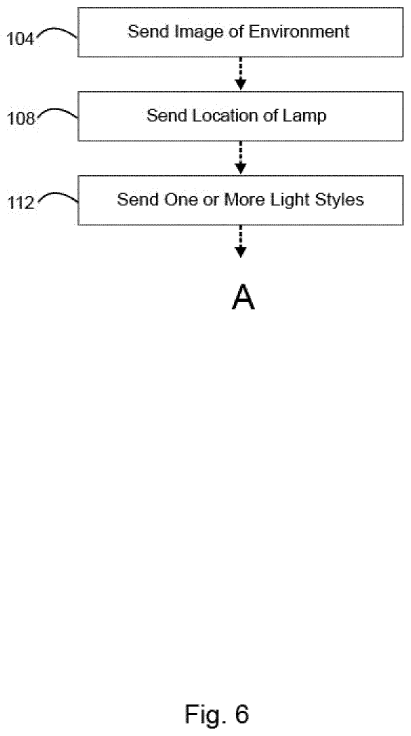

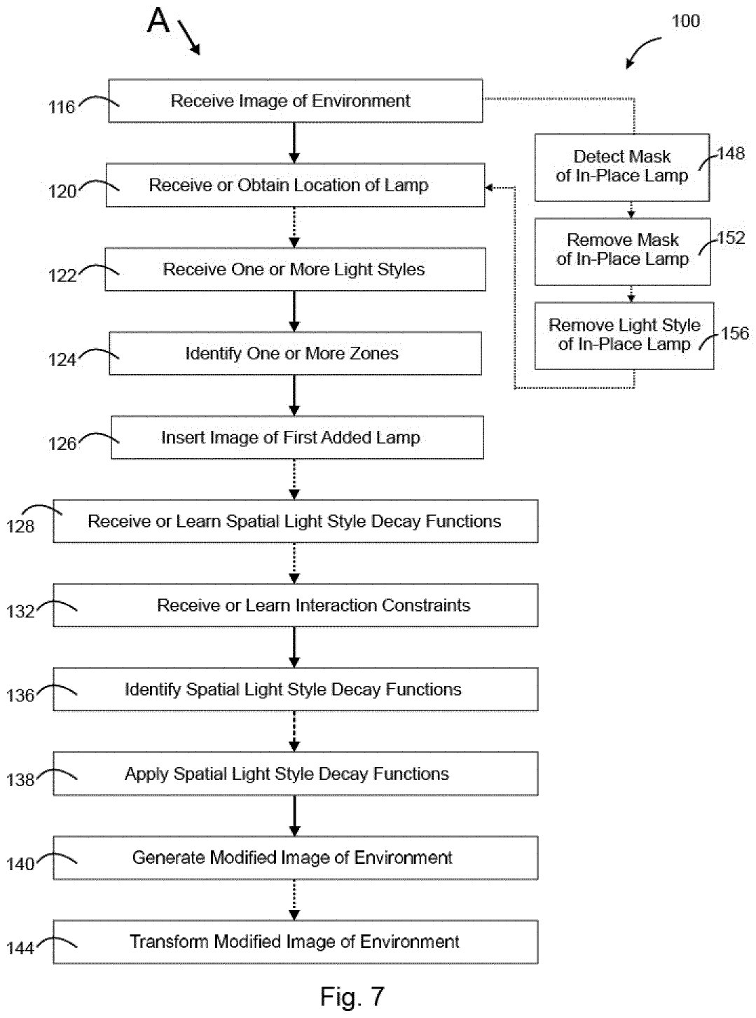

According to an example, first computing device 4 comprises a first processor 16 capable of executing instructions stored in first memory 12 or otherwise processing data to, for example, perform one or more steps of a method for generation of lighting scene images (as shown in FIG. 6 and FIG. 7). Second computing device 20 comprises a second processor 30 capable of executing instructions stored in second memory 28 or otherwise processing data to, for example, perform one or more steps of a method for generation of lighting scene images (as shown in FIG. 6 and FIG. 7). First processor 16 and second processor 30 may be formed of one or multiple modules. First processor 16 and second processor 30 may take any suitable form, including, but not limited to, a microprocessor, microcontroller, multiple microcontrollers, circuitry, field programmable gate array (FPGA), application-specific integrated circuit (ASIC), a single processor, or plural processors.

The first processor 16 and the second processor 30 can be associated with one or more storage media, first memory 12 and second memory 28, respectively (e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors, perform at least some of the functions discussed herein. Various storage media may be fixed within a processor or controller or may be transportable, such that the one or more programs stored thereon can be loaded into a processor so as to implement various aspects of the present disclosure discussed herein.

The first communication module 8 and the second communication module 24 may be wireless transceivers or any other device that enables the first computing device 4 and second computing device 20 to communicate wirelessly with each other as well as other devices utilizing the same wireless protocol standard and/or to otherwise monitor network activity. The first communication module 8 and the second communication module 24 may include one or more devices for enabling communication with other hardware devices. For example, communication modules 8, 24 may include a network interface card (NIC) configured to communicate according to the Ethernet protocol. Additionally, communication modules 8, 24 may implement a TCP/IP stack for communication according to the TCP/IP protocols. Various alternative or additional hardware or configurations for communication modules 8, 24 will be apparent. The communication modules 8, 24 may also use wire/cable and/or fiber optic links.

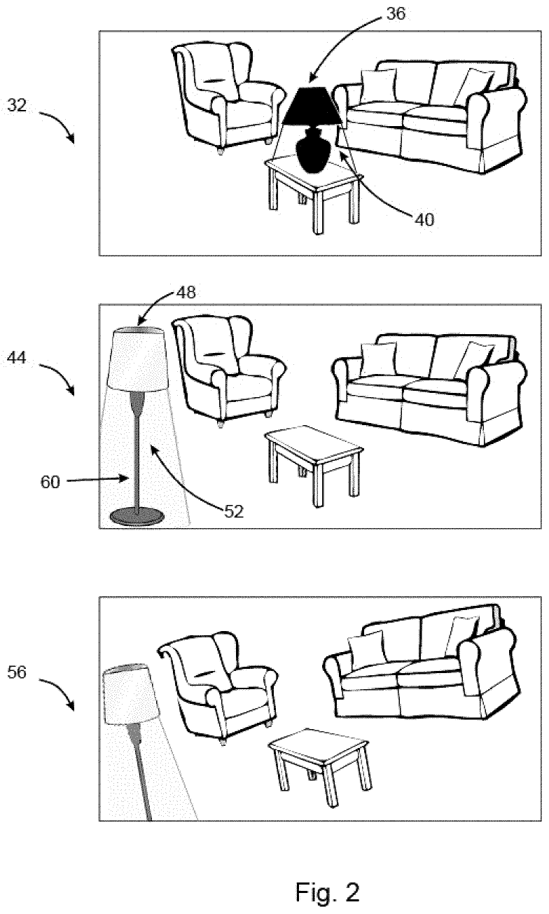

System 10 can generate a lighting scene image which shows one or more added lamps and light styles of the added lamps using conditional generative adversarial networks 68 according to methods disclosed herein. Referring to FIG. 2, an image of an environment 32 is provided by a user. The image of the environment 32 can be an image of an environment, either indoors or outdoors, where the user would like to place one or more lamps. The image of the environment 32 may already contain lamps and the lamps, referred to as in-place lamps 36, may be powered on and providing lighting with a particular light style 40 in the image of the environment 32. In that case, additional steps may be taken to remove the in-place lamps 36 and the light style 40 provided by the in-place lamp 36 from the image of the environment 48. This process is described in further detail in FIG. 7.

Lamp 10 can be any type of lighting fixture, including but not limited to a night light, a table lamp, a hue lamp, a recessed lamp, a floodlight or any other interior or exterior lighting fixture. Light style 52 refers to visible attributes of the light provided by the lamp and the visual effect the light has on the environment and can include color, brightness, spectrum, shadow, reflectivity, hue, color temperature, and other attributes related to light source location. The term “lamp” is used to refer to an apparatus including one or more light sources of same or different types. A given lamp may have any one of a variety of mounting arrangements for the light source(s), enclosure/housing arrangements and shapes, and/or electrical and mechanical connection configurations. Additionally, a given lamp optionally may be associated with (e.g., include, be coupled to and/or packaged together with) various other components (e.g., control circuitry) relating to the operation of the light source(s). An LED-based lighting unit refers to a lighting unit that includes one or more LED-based light sources as discussed above, alone or in combination with other non LED-based light sources.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers. A given light source may be configured to generate electromagnetic radiation within the visible spectrum, outside the visible spectrum, or a combination of both. Additionally, a light source may include as an integral component one or more filters (e.g., color filters), lenses, or other optical components. Also, it should be understood that light sources may be configured for a variety of applications, including, but not limited to, indication, display, and/or illumination.

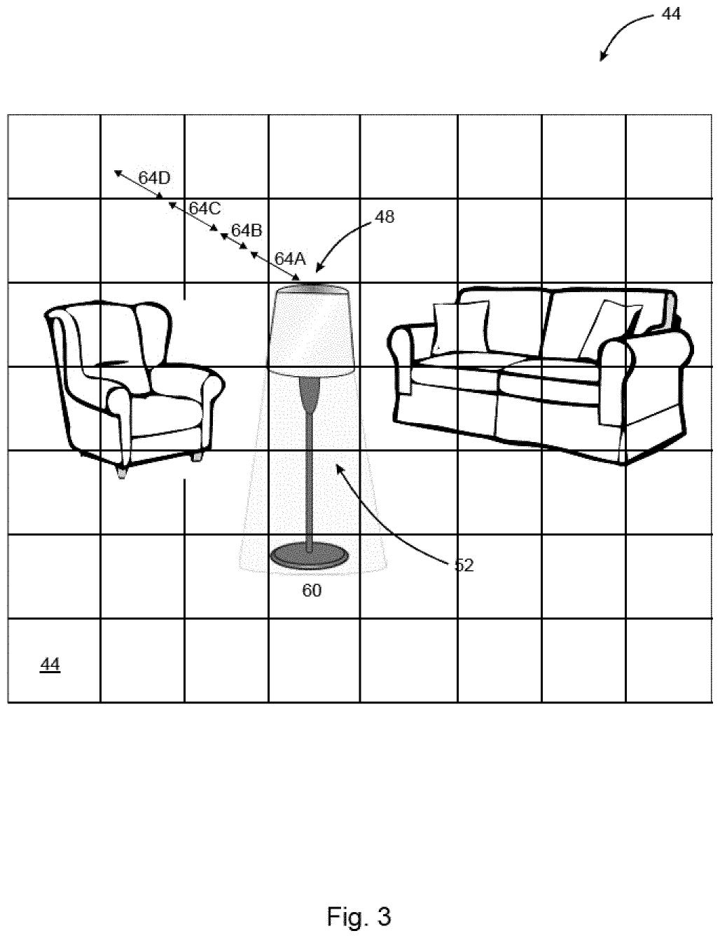

Referring to FIG. 2 and FIG. 3, to create the modified image of an environment 44 a first added lamp 48 is added to a location 60 on the user provided image of the environment. The location 60 may be provided by a user or an artificial intelligence model may propose the location of the lamp to be added. The first added lamp 48 provides light having a light style 52 which is shown in the modified image of the environment 44. A generative adversarial network (“GAN”) is an artificial intelligence model that can generate images. A lamp 48 can be inserted into an image of an environment and the light style 52 from that lamp can also be inserted into the image of the environment using the GAN, generative model, or style transfer model. The image of the lamp is inserted using a mask, or an outline, of the picture of the lamp. The light style 52 is inserted into the image by first identifying one or more zones at varied distances from the added lamp 48. As shown in FIG. 2, Zone 64A, Zone 64B, Zone 64C, and Zone 64D are non-overlapping areas on the image located away from the lamp. Zone 64A is adjacent to the added lamp, Zone 64B is adjacent to Zone 64A, Zone 64C is adjacent to Zone 64B, and Zone 64D is adjacent to Zone 64C, with each zone being at a greater distance from the first added lamp. The GAN, generative model, or style transfer model then applies the light style 52 of the added lamp 48 to the image by inserting the light style 52 according to a spatial light style decay function. The spatial light style decay function is a model for the way that the light style decays the further away from the light source.

As an example, the light style 52 can refer to the brightness of the lamp, where the light is less bright the further away from the lamp radially. The light will be less bright in Zone 64D than in Zone 64C, less bright in Zone 64C than in Zone 64B, and less bright in Zone 64B than in Zone 64A. The GAN, generative model, or style transfer model inserts the light style into the modified image according to particular intensity decay functions which are mathematical models which reflect the way that the light style changes in each zone the further away from the lamp. The light style may be pre-specified as a parameter that is inserted into the algorithm or received by the algorithm. For example, a light style may follow, or be inserted into the modified image, according to a radial decay based on the square distance or a light style may follow, or be inserted into the modified image, according to a pre-parameterized exponential decay mathematical model. As another example, the GAN, generative model, or style transfer model may learn how the light style changes across zones or decays spatially across the image. The GAN, generative model, or style transfer model may learn how the light style decays based on boundaries pre-specified based on light transfer and decay knowledge gained during training.

As an example, the inserted lamp 48 can include more than one light style 52, or more than one lamp can be inserted with one or more light styles 52. The GAN, generative model, or style transfer model has to apply more than one light style 52 to the environment to generate the modified image. For example, two lamps may be inserted into the image in close proximity where one lamp's light style is that it provides blue light and one lamp's light style is that it provides yellow light. As an another example, in areas on the image where light from both lamps shines, the light may be brighter than in areas on the image where light from only one lamp reaches. The color that the light appears on an area where both the blue and yellow lights shine may also vary based on how the blue and yellow lights interact. The GAN, generative model, or style transfer model may be provided with pre-specified interaction constraints between different light styles from added lamps. The GAN/style transfer model can also learn such interactions by itself or in conjunction with the pre-specified interaction or decay constraints. These constraints are inputs to the model which explain how parameters related to different light styles should be factored into the modified image of the environment generated, and may be in the form of an interaction table. Information regarding the interaction constraints and decay functions may also be passed to the model through data augmentation, early loss functions in the model (e.g. inception type intermediate loss interactions), architecture choices, non-linearity choices, weight decay settings or hyperparameter tuning. As an example, for data augmentation, this may consist of overlaying different radial color filters at different pixel locations in the image. This approach for inserting lamps and light styles into an image by focusing on local zones (64A-64D, FIG. 3) around the lamp and then learning the radial local to global transfer of the whole image allows the algorithm to efficiently and on a larger scale transfer lighting styles and create a better modified image. This approach enables style transfer with less data preparation requirements as well as with a more limited dataset compared to other generative adversarial networks.

The methods and system described herein can use generative adversarial networks (“GAN”) to insert lamps into a user-provided image of an environment. A GAN is a machine learning system that can generate images. Generative adversarial networks are deep neural network architectures comprised of two neural networks, discriminative networks or algorithms and generative networks or algorithms. The generative network and the discriminative networks are pitted against each other in a zero-sum game. The generator model tries to generate synthetic images as close as possible to real images, while the discriminator model tries to discriminate between the generated synthetic images and real images. The GAN model tries to minimize the difference between the generated images and the real images until the discriminator or a human can no longer tell the difference between the synthetic and real images. This process can be expressed as a minimax optimization problem with the objective function as follows:

$${min}_{G} {max}_{D} V ( D , G ) = {E}_{x \sim {p}_{data} ( x )} [ log D ( x ) ] + {E}_{z \sim {p}_{noise} ( z )} [ log ( 1 - D ( G ( z ) ) ) ]$$

The discriminator D and the generator G engage in a zero-sum game in which the two alternatively optimize opposite objectives V and −V. By solving the minimax game, the model learns a distribution p_{data}(x) over real data x. The generative network G(z) takes in random noise z˜p(z) and outputs synthetic samples x′=G(z), while the discriminative network D(x) is a classifier which identifies whether a given sample is real or synthetic. x′ is expected to have the same distribution as x when the algorithm reaches Nash equilibrium.

The following equations show the formula for the algorithms described above.

$${x}_{G} = G ( {m}_{j} ⊙ x , j , k , z )$$

$${min}_{G} {max}_{D} V ( D , G ) = {E}_{x \sim {p}_{d a c a} ( x ) , j , k} [ log D ( x , j , k ) ] + {E}_{z \sim {p}_{z} ( z ( Image ) ) , m \sim M} [ log ( 1 - D ( G ( {m}_{j} ⊙ x , j , k , z ) ) ) ] + {λ}_{k} ( StyleConsistency \vert j , M )$$

In the above equations, the mask outline of the lamp to be inserted in the image is m, the-to-be-inserted lamp j, the-to-be-inserted light style (e.g. color) is k, the image outline is M, the discriminator D, the generator G, the latent code or noise is z, and the generator's output is x_{G}=G(m⊙x, j, k, z). The λₖ (StyleConsistency|j, M) component of the equation references a regularization feature which enforces a perceptual color (or lighting intensity, spectrum, shadow, hue, reflectivity, light source locations, etc.) suitability constraint from the in-placed lamp pixels j to the other remaining pixels of the original image conditioned on M. This spatial consistency can be pre-specified or a learned optimal decay parameter within one or more pre-specified boundaries. This function can be based on distance from the in-placed object, intensity, color rendering index, correlated color temperature, and color consistency loss, among other factors. This model enables cycle consistency over these loss functions rather than an L1 norm loss alone. In addition, rather than the model searching over the entire image to calibrate loss parameters, the search space is restricted, which enables the model to converge early.

The GAN could utilize any context aware conditional generative adversarial network which contains one or more generator models and one or more discriminator models. One or more generator models can include, any neural network, for example, an up sampling convolution architecture such as a convolution neural network (e.g. VGG), residual network (e.g. ResNet or Inception-ResNet), decoder network, generative adversarial model, auto-encoder, restricted Boltzmann machine, latent Dirichlet allocation, hidden Markov model, amongst others, or any other generator model architecture. A discriminator model can include, for example, any neural network (e.g. encoder network or down-sampling neural network), support vector machine, entropy-based Markov models, logistic regressors, a simple feature extractor, or any other discriminative model architecture. The model of the present disclosure can consist of different combinations of these models, e.g. number of models, hierarchy, resolution or conditioned inputs.

An auto-encoder is a type of artificial neural network used to learn efficient data coding in an unsupervised manner. The aim of an auto-encoder is to learn a representation (encoding) for a set of data, typically for dimensionality reduction, by training the network to ignore signal noise. Along with the reduction side, a reconstructing side is learned, where the auto-encoder tries to generate from the reduced encoding a representation as close as possible to its original input. A restricted Boltzmann machine is a generative stochastic artificial neural network that can learn a probability distribution over its set of inputs. Restricted Boltzmann machines are a variant of Boltzmann machines, with the restriction that their neurons form a bipartite graph. A pair of nodes from each of the two groups of units may have a symmetric connection between them, and there are no connections between nodes within a group. A hidden Markov model is a statistical model in which the system being modeled is assumed to be a Markov process with unobserved (i.e. hidden) states. The hidden Markov model can be represented as the simplest dynamic Bayesian network.

Neural networks are sets of algorithms, modeled loosely after the human brain, that are designed to recognize patterns. They interpret sensory data through a type of machine perception, labeling or clustering raw input. The patterns they recognize are numerical, contained in vectors, into which all data, images, sound, text or time series, is translated. Support vector machines are supervised learning models with associated learning algorithms that analyze data used for classification and regression analysis. Given a set of training examples, each marked as belonging to one or the other of two categories, a support vector machine training algorithm builds a model that assigns new examples to one category or the other. Entropy-based Markov models are discriminative models that assume that the unknown values to be learnt are connected in a Markov chain rather than being conditionally independent of each other. A feature extractor is a type of machine learning involving pattern recognition and image processing which starts from an initial set of measured data and builds derived values (features) intended to be informative and non-redundant, facilitating the subsequent learning and generalization steps.

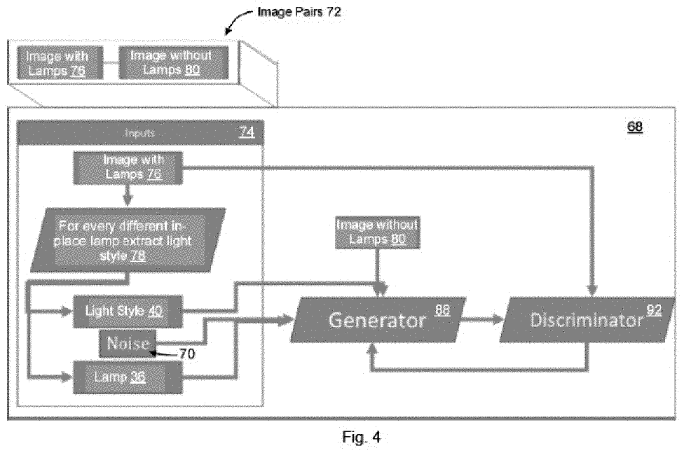

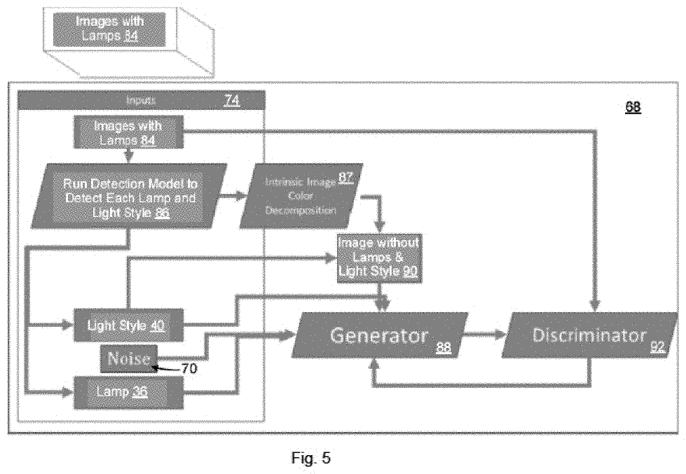

The GAN is trained by utilizing a known dataset as the initial training data for the discriminator. Training the discriminator model involves presenting the discriminator with samples from the training dataset until the discriminator achieves acceptable accuracy. The generator is trained based on whether it succeeds in fooling the discriminator. Back propagation is applied in both networks so that the generator produces better images, while the discriminator becomes more skilled at flagging synthetic images. FIG. 4 shows an exemplary training approach for the GAN 68 where the GAN 68 is trained using image pairs 72 where one image of the image pairs shows an environment with in-place lamps 76 and another image of the image pairs shows an environment without in-place lamps 80. The inputs 74 include the multiple images with in-place lamps 76. The images without in-place lamps 80 are sent to generator 88, and the images with in-place products are sent to the discriminator 92. The in-place light style 40 and in-place lamp 36 are extracted for every different lamp 78 in the images with in-place lamps 76. The in-place light style 40 and in-place lamp 36, along with any noise 70, are sent to the generator. The generator 88 and discriminator 92 loop and work in conjunction with each other to reach acceptable accuracy. FIG. 5 shows an exemplary training approach for the GAN 68 where the GAN 68 is trained with images with one or more in-place lamps 84. The inputs 74 include the multiple images with one or more in-place lamps 84. A detection model is used to detect each lamp and each light style within the images 86. The light styles 40 and lamps 36, along with any noise 70, are sent to the generator 88. Intrinsic image color decomposition 87 removes the lamps 36 and light styles 40, and an image without light style and lamps is sent 90 to the generator 88. The generator 88 and discriminator 92 loop and work in conjunction with each other to reach acceptable accuracy. Through training the generator(s) in the GAN can learn any possible lighting or domain transformations until the images that are generated look very realistic and are not differentiable to the discriminator(s) from the training or target dataset. Paired data sets are not needed as the model can be trained in an unpaired manner (e.g. using Cycle-GAN or Star-GAN). Similarly images of real lighted sources might not be needed if a simulator to generate simulated representations exists. Another GAN can learn to transform the simulated representation to pseudo-real images which can then be used in training. These two models can also be combined.

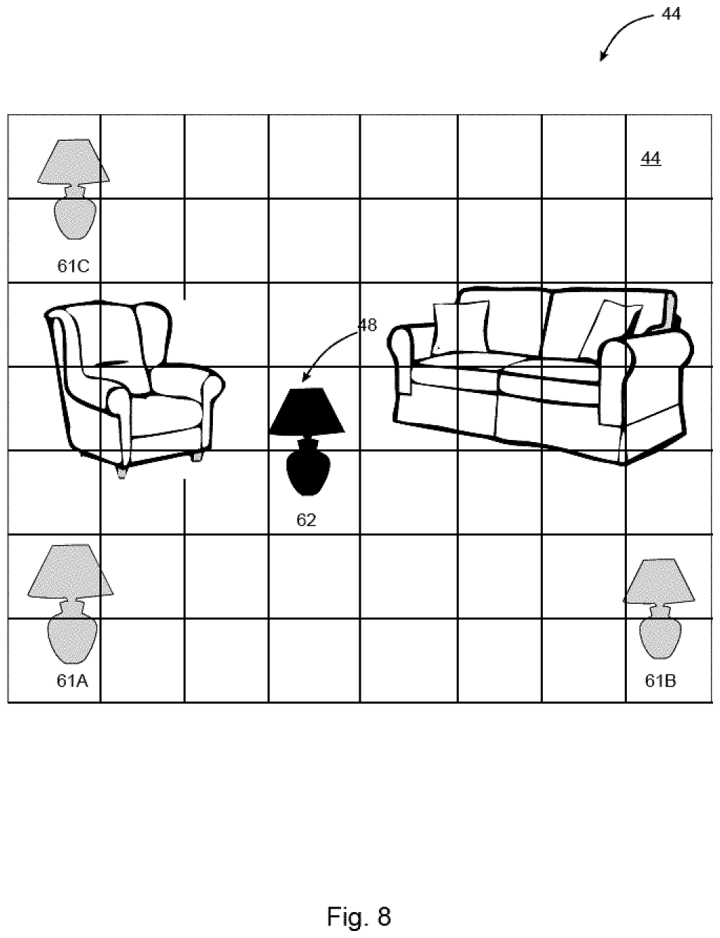

For the artificial intelligence mechanism to learn a suitable location 62 where an added lamp can be inserted (shown in FIG. 8) into the image of the environment, a region proposal segmentation based neural network or a modified object detection network (for example, mask region convolutional neural networks, object detection, e.g., YOLO, or any other convolutional neural networks) can be used. These models are first adapted to classify the type and location of all objects in the space (i.e., image of the environment). These models then propose regions of best fit for a lamp to be inserted by minimizing an overall aesthetic suitability metric over the whole image. A location 62 for the added lamp to be inserted is chosen over one or more other choices for locations 61A, 61B, 61C by selecting the location 62 with the best aesthetic score. The aesthetic suitability metrics are learned using training images of environments with inserted lamps. The models learn where lamps are inserted in the training images. For example, the inserted lamps in the training images may be located at a certain position with respect to other objects, such as furniture (e.g., on a table or behind a sofa); in a spatial location (e.g., in the center of a room or in the corner of the room); or according to a particular arrangement (e.g., two lamps located symmetrically in the room); among others. The aesthetic suitability metrics are learned by minimizing loss functions such as area IOU, bound in box intersection, perceptual loss, pixel loss, total variation regulation, or intersection of union, among others.

FIG. 6 shows exemplary steps in method 100 for automated generation of lighting scene images. At optional step 104, the first computing device 4 (shown in FIG. 1) sends, to the second computing device 20, via the first communication module 8, an image of an environment 32 (shown in FIG. 2). The first computing device 4 sends, to the second computing device via the first communication module, a location 60 on the image of an environment of a first added lamp 48 (shown in FIG. 2 and FIG. 3), at optional step 108. The first computing device 4 sends, at optional step 112, to the second computing device via the first communication module, one or more light styles 52 regarding the first added lamp 48.

FIG. 7 shows steps in an exemplary method for generating lighting scene images, which can be performed with the features described above and in reference to FIG. 1-FIG. 5 & FIG. 8. The second computing device 20 receives, at step 116, from the first computing device 4 via the second communication module 24, an image of an environment 32. At step 120, the second computing device either receives a location 60 on the image of an environment to add the first added lamp 48 or obtains the learned location 62 (shown in FIG. 8) on the image of an environment to add the first added lamp 48. The location on the image of an environment may be received from the first computing device via the second communication module. The location on the image of an environment may also be learned by a modified object detection network or a regional proposal segmentation based neural network on the second computing device, in which case the learned location is obtained from the second computing device.

At step 124, the second computing device 20 identifies one or more zones 64 at varied distances from the first added lamp 48. At step 126, an image of the first added lamp 48 is inserted onto the image of the environment. This image may be added first as a mask or an outline of the lamp and then a more complete and photo-realistic image of the lamp may be generated. At optional step 128, the second computing device receives or learns one or more spatial light style decay functions. These spatial light style decay functions may be pre-specified or learned by the GAN, generative model, or style transfer model. For example, the GAN model may also learn how the light style decays based on boundaries pre-specified based on light transfer and decay knowledge gained during training. At optional step 132, the second computing device receives or learns one or more interaction constraints regarding light style. These constraints may be pre-specified inputs to the model which explain how parameters related to different light styles should be factored into the modified image of the environment generated. These constraints may also be learned. The GAN/style transfer model can learn such constraints by itself or in conjunction with pre-specified interaction or decay constraints. The second computing device 20 identifies, at step 136, one or more spatial light style decay functions suitable to the image of an environment based on the first added lamp. At optional step 138, one or more spatial light style decay functions are applied to the image of the environment. At step 140, the second computing device generates, using a conditional generative adversarial network, a modified image of an environment 44, wherein the modified image 44 shows the first added lamp 48 and shows one or more light styles 52 from the first added lamp. The second processor 30 of the second computing device 20 is further configured to transform, at optional step 144, the modified image at a global scale. The global level changes to the image can include rotating the modified image 56 (shown in FIG. 2), altering a view point of the modified image, changing ambient background conditions such as those related to seasons or weather, and any other global imaging changes. Generator models, particularly adversarial networks, can make such transformations. To enable better and quicker convergence, different approaches are used, including using style consistency constraints which can be enforced through pixel state transformation priors, using convergence constraints, and data augmentation using radial lighting filters, amongst others.

If the image of the environment provided by the user includes in-place lamps 36 with in-place lamp light styles 40 (shown in FIG. 2), then the in-place lamps 36 with in-place lamp light styles 40 may be removed before the system inserts the first added lamp 48 and the first added lamp style 52. Exemplary steps to remove in-place lamps 36 and the in-place lamp lighting style 40 are shown in FIG. 7. First a segmentation-based detection model is run to detect a mask of the in-place lamp at optional step 148. The mask of the in-place lamp is removed at optional step 152. The light style of the in-place lamp is removed, at optional step 156, using image decomposition.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of”.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method for automated generation of lighting scene images, comprising:
receiving an image of an environment;
receiving a location on the image of an environment of a first lamp or obtaining a learned location on the image of an environment of the first lamp;
identifying one or more zones at varied distances from the first added lamp;
inserting an image of the first lamp on the image of an environment;
identifying one or more spatial light style decay functions suitable to the image of an environment based on the first added lamp; and
generating, using a conditional generative adversarial network, a modified image of an environment, wherein the modified image shows the first added lamp and shows one or more light styles from the first added lamp, the one or more light styles being based on the identified one or more spatial light style decay functions, and associated with the one or more identified zones.

2. The method of claim 1, further comprising:
receiving or learning one or more interaction constraints regarding light style.

3. The method of claim 1, wherein the received or learned location on the image of the environment to insert the first lamp is determined by a modified object detection network or a regional proposal segmentation based neural network.

4. The method of claim 1, further comprising the step of transforming the modified image using the conditional generative adversarial network or style transfer network, wherein transforming the modified image comprises at least one of: rotating the modified image; altering a view point of the modified image; and
changing ambient background conditions.

5. The method of claim 1, wherein the conditional generative adversarial network comprises one or more generator models and one or more discriminator models.

6. The method of claim 1, wherein the one or more light styles are regarding at least one of: color, brightness, spectrum, shadow, reflectivity, hue, and light source location.

7. The method of claim 1, wherein the conditional generative adversarial network is trained using image pairs where one image of the image pairs shows an environment with in-place lamps and another image of the image pairs shows an environment without in-place lamps.

8. The method of claim 1, wherein the conditional generative adversarial network is trained using images with one or more in-place lamps, further comprising the steps of:
running a detection model to detect a mask of the one or more in-place lamps and lamp styles of the one or more in-place lamps;
removing the mask of the one or more in-place lamps; and
removing one or more in-place lamp styles using image decomposition.

9. A system for automated generation of lighting scene images, comprising:
a first computing device, having a first communication module, a first memory, and a first processor, wherein the first processor is configured to:
send, to a second computing device via the first communication module, an image of an environment; and
the second computing device, having a second communication module, a second memory, and a second processor, wherein the second processor is configured to:
receive, from the first computing device via the second communication module, an image of an environment;
receive a location on the image of an environment of a first lamp or obtain a learned location on the image of an environment of a first lamp, from the first computing device or the second computing device;
identify one or more zones at varied distances from the first lamp;
insert an image of the first lamp on the image of an environment;
receive or learn one or more spatial light style decay functions; and
generate, using a conditional generative adversarial network, a modified image of an environment, wherein the modified image shows the first added lamp and shows one or more light styles from the first added lamp, the one or more light styles being based on the one or more spatial light style decay functions, and associated with the one or more identified zones.

10. The system of claim 9, wherein the second computing device is further configured to:
receive or learn one or more interaction constraints regarding light style.

11. The system of claim 9, wherein the first processor of the first computing device is further configured to: send, to the second computing device via the first communication module, one or more light styles regarding the first added lamp.

12. The system of claim 9, wherein the second processor of the second computing device is further configured to: transform the modified image using the conditional generative adversarial network or style transfer network, wherein transforming the modified image comprises at least one of: rotating the modified image; altering a view point of the modified image; and changing ambient background conditions.

13. The system of claim 9, wherein the conditional generative adversarial network comprises one or more generator models and one or more discriminator models.

14. The system of claim 9, wherein the one or more light styles are regarding at least one of color, brightness, spectrum, shadow, reflectivity, hue, and light source location.
